(19) United States
(12) Patent Application Publication
(10) Pub. No.: US 2019/0389579 A1
(43) Pub. Date: Dec. 26, 2019

(54) METHOD FOR CONTROLLING UAV

(71) Applicant: SZ DJI TECHNOLOGY CO., LTD., Shenzhen (CN)

(72) Inventor: Hong ZHOU, Shenzhen (CN)

(21) Appl. No.: 16/533,156

(22) Filed: Aug. 6, 2019

Related U.S. Application Data
(63) Continuation of application No. PCT/CN2017/073348, filed on Feb. 13, 2017.

(51) Int. Cl. B64C 39/02; G05D 1/00; G06K 9/00

(52) U.S. Cl. CPC B64C 39/024; G05D 1/0016; G06K 9/00255; G06K 9/00268; G06K 9/00288; G06K 2009/00395; G06K 9/00604; G06K 9/00617; G06K 9/0061; G06K 9/00369; B64C 2201/146; G06K 9/00389

(57) ABSTRACT

A method for controlling an unmanned aerial vehicle (UAV) includes obtaining identity information of a user, determining a user permission according to the identity information and a preset database, and controlling the UAV according a control command generated based on the user permission.

### CROSS-REFERENCE TO RELATED APPLICATION

This application is a continuation of International Application No. PCT/CN2017/073348, filed on Feb. 13, 2017, the entire content of which is incorporated herein by reference.

### TECHNICAL FIELD

The present disclosure relates to aircraft technology and, more particularly, to a method for controlling an unmanned aerial vehicle (UAV), a UAV, and a remote-control device.

### BACKGROUND

Currently, an unmanned aerial vehicle (UAV) does not set the user authentication and permissions. Once the UAV is lost or stolen, the UAV can be used by anyone. If the UAV is used arbitrarily by others, security issues of the UAV and the privacy of the UAV are easily caused.

### SUMMARY

In accordance with the disclosure, there is provided a method for controlling an unmanned aerial vehicle (UAV) including obtaining identity information of a user, determining a user permission according to the identity information and a preset database, and controlling the UAV according a control command generated based on the user permission.

### BRIEF DESCRIPTION OF THE DRAWINGS

FIG. 1 is a flowchart of a method for controlling an unmanned aerial vehicle (UAV) according to an embodiment of the disclosure.

FIG. 2 is a schematic diagram of a UAV according to an embodiment of the disclosure.

FIG. 3 is a schematic diagram of a remote-control device according to an embodiment of the disclosure.

FIG. 4 is a flowchart of another method for controlling a UAV according to an embodiment of the disclosure.

FIG. 5 is a schematic diagram of a UAV or a remote-control device according to an embodiment of the disclosure.

FIG. 6 is a flowchart of another method for controlling a UAV according to an embodiment of the disclosure.

FIG. 7 is a schematic diagram of a UAV or a remote-control device according to an embodiment of the disclosure.

FIG. 8 is a flowchart of another method for controlling a UAV according to an embodiment of the disclosure.

FIG. 9 is a schematic diagram of a UAV or a remote-control device according to an embodiment of the disclosure.

FIG. 10 is a flowchart of another method for controlling a UAV according to an embodiment of the disclosure.

FIG. 11 is a schematic diagram of a UAV or a remote-control device according to an embodiment of the disclosure.

FIG. 12 is a flowchart of another method for controlling a UAV according to an embodiment of the disclosure.

FIG. 13 is a schematic diagram of a UAV or a remote-control device according to an embodiment of the disclosure.

FIG. 14 is a flowchart of another method for controlling a UAV according to an embodiment of the disclosure.

FIG. 15 is a schematic diagram of a UAV or a remote-control device according to an embodiment of the disclosure.

FIG. 16 is a flowchart of another method for controlling a UAV according to an embodiment of the disclosure.

FIG. 17 is a schematic diagram of a UAV or a remote-control device according to an embodiment of the disclosure.

FIG. 18 is a flowchart of another method for controlling a UAV according to an embodiment of the disclosure.

FIG. 19 is a schematic diagram of a UAV or a remote-control device according to an embodiment of the disclosure.

### DETAILED DESCRIPTION OF THE EMBODIMENTS

Example embodiments will be described with reference to the accompanying drawings, in which the same numbers refer to the same or similar elements unless otherwise specified. It will be appreciated that the described embodiments are merely examples for the purpose of illustration and are not intended to limit the scope of the disclosure.

The terms “first,” “second,” or the like in the specification, claims, and the drawings of the disclosure are merely illustrative, e.g. distinguishing similar elements, defining technical features, or the like, and are not intended to indicate or imply the importance of the corresponding elements or the number of the technical features. Thus, features defined as “first” and “second” may explicitly or implicitly include one or more of the features. As used herein, “multiple” means two or more, unless there are other clear and specific limitations.

As used herein, the terms “mounted,” “coupled,” and “connected” should be interpreted broadly, unless there are other clear and specific limitations. For example, the connection between two assemblies may be a fixed connection, a detachable connection, or an integral connection. The connection may also be a mechanical connection, an electrical connection, or a mutual communication connection. Furthermore, the connection may be a direct connection or an indirect connection via an intermedium, an internal connection between the two assemblies or an interaction between the two assemblies. The meaning of the terms can be understood by those of ordinary skill in the art according to a specific scenario.

Various example embodiments corresponding to different implementations of the disclosure will be described. For simplification purposes, the elements and configurations for the specific embodiments are described below. It will be appreciated that the described embodiments are example only and not intended to limit the scope of the disclosure. Moreover, the references of numbers or letters in various example embodiments are merely for the purposes of clear and simplification, and do not indicate the relationship between the various example embodiments and/or configurations. In addition, the use of other processes and/or materials will be apparent to those skilled in the art from consideration of the examples of various specific processes and materials disclosed herein.

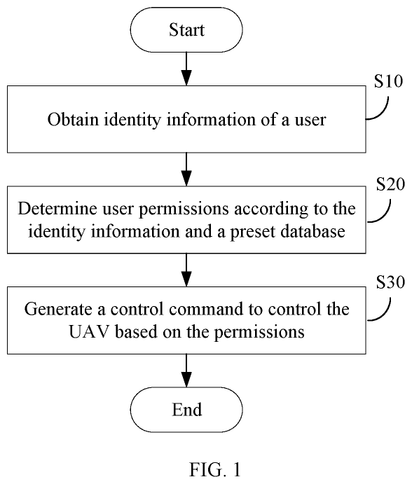

FIG. 1 is a flowchart of an example method for controlling an unmanned aerial vehicle (UAV) consistent with the disclosure. As shown in FIG. 1, at S10, identity information of a user is obtained.

At S20, user permissions are determined according to the identity information and a preset database.

At S30, a control command is generated to control the UAV based on the permissions.

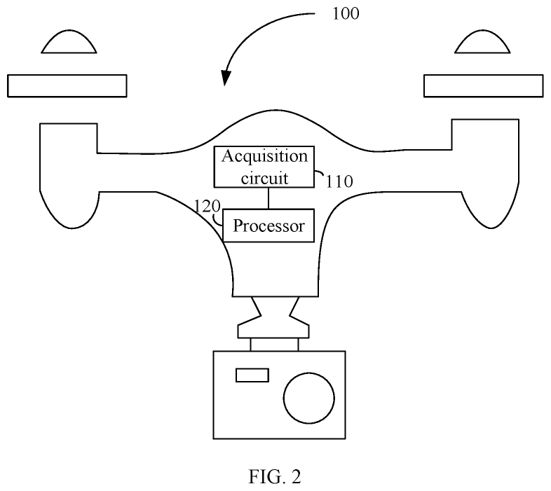

FIG. 2 a schematic diagram of a UAV 100 consistent with the disclosure. As shown in FIG. 2, the UAV 100 includes an acquisition circuit 110 and a processor 120. In some embodiments, the method shown in FIG. 1 can be implemented by the UAV 100 shown in FIG. 2.

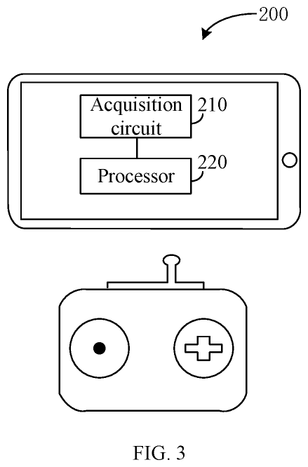

FIG. 3 is a schematic diagram of a remote-control device 200 consistent with the disclosure. As shown in FIG. 3, the remote-control device 200 includes an acquisition circuit 210 and a processor 220. In some embodiments, the method shown in FIG. 1 can be implemented by the remote-control device 200 shown in FIG. 3.

The process of the method at S10 can be implemented by the acquisition circuit 110 or the acquisition circuit 210, and the process of the method at S20 can be implemented by the processor 120 or the processor 220. That is, the acquisition circuit 110 or the acquisition circuit 210 can be configured to obtain the identity information of the user, and the processor 120 or the processor 220 can be configured to determine the user permissions according to the identity information and the preset database.

In some embodiments, the UAV 100 and the remote-controller device 200 can each include the acquisition circuit and the processor to obtain and detect the identity information of the user and determine the user permissions. In some embodiments, one of the UAV 100 and the remote-controller device 200 can include the acquisition circuit and the processor. In some other embodiments, the UAV 100 and the remote-controller device 200 can include one of the acquisition circuit and the processor, respectively. For example, the UAV 100 can include the acquisition circuit and the remote-controller device 200 can include the processor. As another example, the remote-controller device 200 can include the acquisition circuit and the UAV 100 can include the processor. In this scenario, the remote-control device 200 and the UAV 100 can communicate with each other to complete the identity authentication.

With the development and popularization of the UAVs, the use of UAVs has become more and more private. However, the conventional UAVs do not have any protection for the privacy of the UAVs, and thus security risks can be caused. For example, for the users having different levels of familiarity with the operating skills of the UAV, when the users are operating the same UAV, if the operating permissions for different users are not set, the safety hazards in a flight control of the UAV can be caused. As another example, if the UAV is lost or stolen, other persons can easily use the UAV, thereby causing a security risk in the privacy of the UAV including the shooting content.

In some embodiments, before the user controls the UAV 100, the current user permissions can be determined by matching a detection of the user identity information with the preset database, thereby authorizing the user to control the UAV 100 to fly according to the permissions.

The preset database can be established when the user sets the UAV 100 for the first time, and the acquisition circuit 110 or 210 can perform the entry of the identity information and sets the permissions that match the identity information. When the UAV 100 is operated again, the user permissions are first confirmed, and then the UAV 100 can be controlled to perform the related operations. When a new user needs to be added, the operation can be performed under the authorization of the user who has the permissions of adding new users, such that the matching between new identity information and the permissions can be established.

In some embodiments, the permissions can include starting the UAV 100, prohibiting the UAV 100 from flying, limiting flight parameters of the UAV 100, limiting a flight attitude of the UAV 100, and limiting any one or more of shooting, tracking, and obstacle avoidance functions of the UAV 100. Furthermore, the flight parameters can include the flight altitude, a flight distance, or the like, and the flight attitude can include tilt or the like. The permissions of the UAV 100 can include, but are not limited to, the above-described permissions, and can also include, for example, the permission to add a new user, which is not limited herein.

Generally, an owner of the UAV 100 can have the highest permissions. A user who operates the UAV first will be set as the owner by default. In the process of adding a new user, the owner can assign permissions to the new user based on the new user's situation, such as age, familiarity with the UAV, and/or the like. The owner can also modify the permissions during the subsequent use to meet the needs of different users. For example, a user A is the owner and has the highest permissions. A user B is a child. The owner can authorize some permissions, such as a flying distance of 100m, a flying height of 10m, a flight time of 5 minutes, forbidding to use other functions except than the flight, and other flying attitudes other than the normal attitude, to the child, according to the corresponding settings. As such, the user A and user B can control the UAV 100 within their respective user permissions.

Consistent with the disclosure, the method for controlling the UAV, the UAV 100, and the remote-control device 200 can determine the user permissions by obtaining the user identity information and matching the user identity information with the preset database, and authorize the user to control the UAV with the corresponding permissions. Therefore, the safety and privacy of UAV can be improved.

In some embodiments, the UAV 100 can be a quadrotor aircraft, i.e., an aircraft with four rotor assemblies. In some embodiments, the UAV 100 can be a monorotor aircraft, a hexarotor aircraft, an octorotor aircraft, a doderotor aircraft, or the like. In some other embodiments, the UAV 100 may be a fixed-wing aircraft or a rotor-fixed wing hybrid aircraft, which is not limited herein.

In some embodiments, the remote-control device 200 can include any one of a remote controller having a screen, a mobile phone, a tablet computer, a ground station, a computer, smart glasses, a smart helmet, a smart bracelet, and a smart watch.

In some embodiments, comparing with arranging the acquisition circuit at the UAV 100, implementing the acquisition circuit by an associated functional circuit on the remote-control device 200 can save the cost. Arranging the acquisition circuit at the UAV 100 can facilitate the user to operate at either end (i.e., at the UAV 100 or at the remote-control device 200).

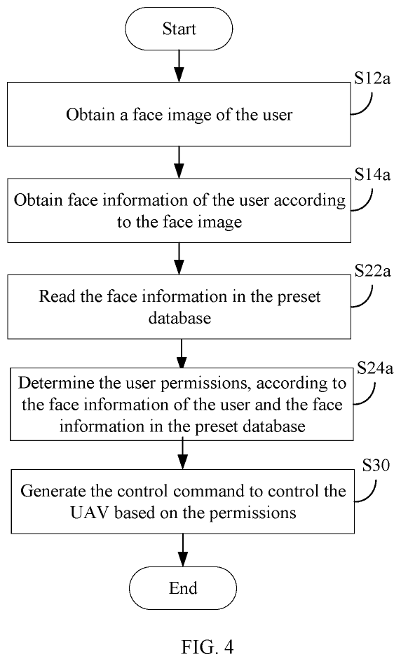

FIG. 4 is a flowchart of another example method for controlling the UAV consistent with the disclosure. In some embodiments, as shown in FIG. 4, the process at S10 can include the following processes.

At S12a, a face image of the user is obtained.

At S14a, face information of the user is obtained according to the face image.

In this scenario, the process at S20 can include the following processes.

At S22a, the face information in the preset database is read.

At S24a, the user permissions are determined according to the face information of the user and the face information in the preset database.

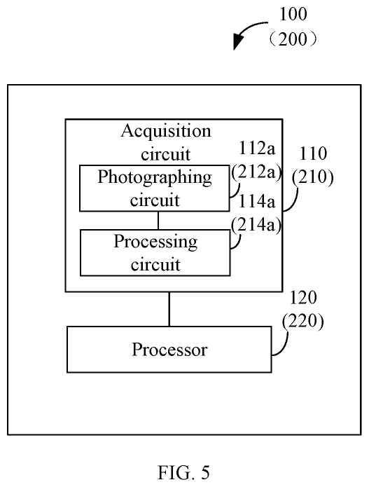

FIG. 5 is a schematic diagram of the UAV 100 or the remote-control device 200 consistent with the disclosure. In some embodiments, as shown in FIG. 5, the acquisition circuit 110 includes a photographing circuit 112a and a processing circuit 114a. Similarly, the acquisition circuit 210 includes a photographing circuit 212a and a processing circuit 214a. The process at 512a can be implemented by the photographing circuit 112a or the photographing circuit 212a, and the process at 514a can be implemented by the processing circuit 114a and the processing circuit 214a. That is, the photographing circuit 112a or the photographing circuit 212a can be configured to obtain the face image of the user, and the processing circuit 114a and the processing circuit 214a can be configured to obtain the face information of the user according to the face image.

In some embodiments, the process at S22a and the process at S24a can be implemented by the processor 120 or the processor 220. That is, the processor 120 or the processor 220 can be configured to read the face information in the preset database and determine the user permissions according to the face information of the user and the face information in the preset database.

In some embodiments, the photographing circuit 112a can include a camera of the UAV 100 and the photographing circuit 212a can include a camera of the remote-control device 200, for example, a phone.

An example is described below taking a user A and a user B as an example. During the first-time operation of the UAV 100 by the user A, the camera of the corresponding device (the UAV 100 or the remote-control device 200) can be controlled to obtain the face image of the user A, and the face image can be stored. The processing circuit 114a or the processing circuit 214a can extract feature information of the face as the face information of the user A, according to the obtained face image. The user A can further set the user permissions that match the face information. In addition, because the user A is operating the UAV 100 for the first time, the user A will be set as the owner by default or set himself as the owner, and thus the user A can have all permissions. After the match between the face image of the user A and the user permissions is established, the preset database can be created.

When the user A operates the UAV 100 again, the camera can be controlled to capture the face image, the face image can be processed to obtain the face information, and the processor can compare the obtained face information with the face information in the preset database. If the matching between the obtained face information and the face information in the preset database is successful, the user A can be confirmed as an authorized user, and the permissions of the user A can be further determined. Similarly, if the user B operates the UAV 100, the obtained face information will fail to match the face image in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the face information of the user B. As such, the user B can become the authorized user. In a subsequent operation, after the user B passes the match of the face information, the user B can obtain the corresponding permissions to control the UAV 100. Users other than the user A and the user B will not have the permission to operate the UAV 100, which improves the security of the UAV 100.

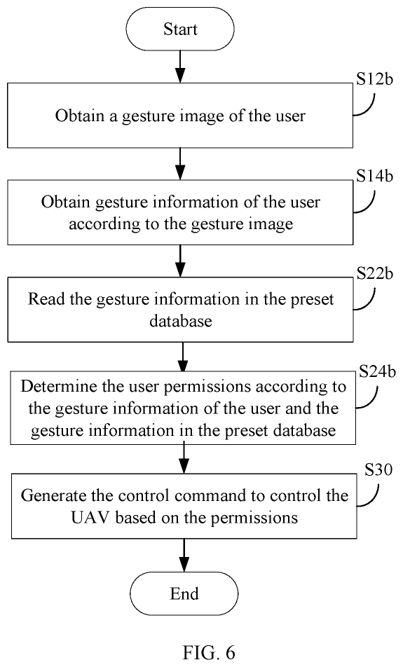

FIG. 6 is a flowchart of another example method for controlling the UAV consistent with the disclosure. In some embodiments, as shown in FIG. 6, the process at S10 can include the following processes.

At 512b, a gesture image of the user is obtained.

At S14b, gesture information of the user is obtained according to the gesture image.

In this scenario, the process at S20 can include the following processes.

At S22b, the gesture information in the preset database is read.

At S24b, the user permissions are determined according to the gesture information of the user and the gesture information in the preset database.

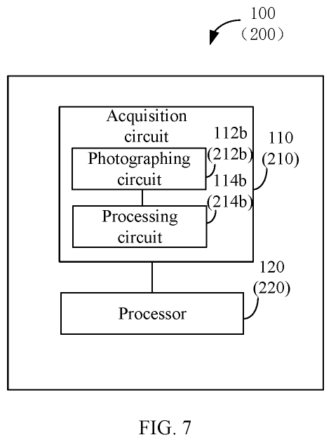

FIG. 7 is a schematic diagram of the UAV 100 or the remote-control device 200 consistent with the disclosure. In some embodiments, as shown in FIG. 7, the acquisition circuit 110 includes a photographing circuit 112b and a processing circuit 114b. Similarly, the acquisition circuit 210 includes a photographing circuit 212b and a processing circuit 214b. The process at 512b can be implemented by the photographing circuit 112b or the photographing circuit 212b, and the process at 514b can be implemented by the processing circuit 114b and the processing circuit 214b. That is, the photographing circuit 112b or the photographing circuit 212b can be configured to obtain the gesture image of the user, and the processing circuit 114b and the processing circuit 214b can be configured to obtain the gesture information of the user according to the gesture image.

In some embodiments, the process at S22b and the process at S24b can be implemented by the processor 120 or the processor 220. That is, the processor 120 or the processor 220 can be configured to read the gesture information in the preset database and determine the user permissions according to the gesture information of the user and the gesture information in the preset database.

In some embodiments, the photographing circuit 112b can include a camera of the UAV 100 and the photographing circuit 212b can include a camera of the remote-control device 200, for example, a phone.

An example is described below taking the user A and the user B as an example. During the first-time operation of the UAV 100 by the user A, the camera of the corresponding device (the UAV 100 or the remote-control device 200) can be controlled to obtain a plurality of gesture images of the user A, and the plurality of gesture images can be stored. The processing circuit 114b or the processing circuit 214b can extract feature information of the gesture as the gesture information of the user A, according to the obtained gesture images. The user A can further set the user permissions that match the gesture information. In addition, because the user A is operating the UAV 100 for the first time, the user A will be set as the owner by default or set himself as the owner, and thus the user A can have all permissions. After the match between the gesture image of the user A and the user permissions is established, the preset database can be created. The gesture images may include a plurality of continuous images of a certain action sequence of the user A, and the gesture information can be an action sequence or form information extracted from the plurality of images. That is, the gesture information can include a plurality of pieces of feature information. Gesture information is more secure than single facial information because the composition of the gesture information contains multiple information features.

When the user A operates the UAV 100 again, the camera can be controlled to capture the gesture image, the gesture image can be processed to obtain the gesture information, and the processor can compare the obtained gesture information with the gesture information in the preset database. If the matching between the obtained gesture information and the gesture information in the preset database is successful, the user A can be confirmed as an authorized user, and the permissions of the user A can be further determined. Similarly, if the user B operates the UAV 100, the obtained gesture information will fail to match the gesture image in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the gesture information of the user B. As such, the user B can become the authorized user. In the subsequent operation, after the user B passes the match of the gesture information, the user B can obtain the corresponding permissions to control the UAV 100. Users other than the user A and the user B will not have the permission to operate the UAV 100, which improves the security of the UAV 100.

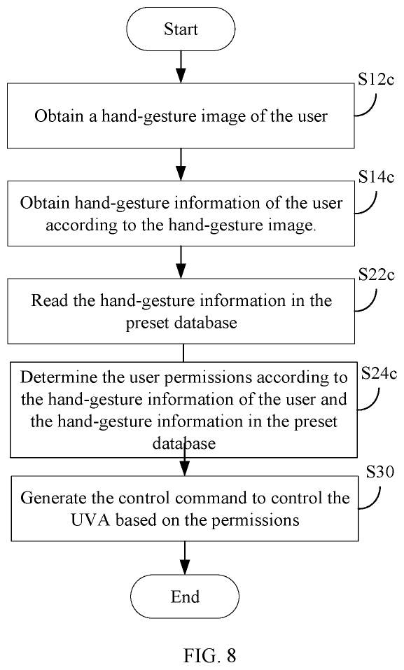

FIG. 8 is a flowchart of another example method for controlling the UAV consistent with the disclosure. In some embodiments, as shown in FIG. 8, the process at S10 can include the following processes.

At 512c, a hand-gesture image of the user is obtained.

At 514c, hand-gesture information of the user is obtained according to the hand-gesture image.

In this scenario, the process at S20 can include the following processes.

At S22c, the hand-gesture information in the preset database is read.

At S24c, the user permissions are determined according to the hand-gesture information of the user and the hand-gesture information in the preset database.

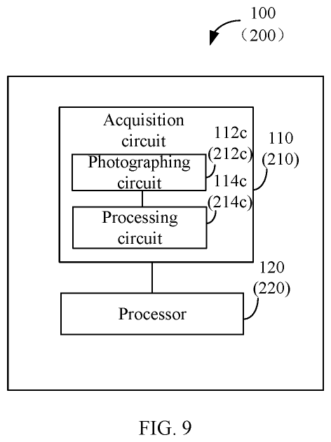

FIG. 9 is a schematic diagram of the UAV 100 or the remote-control device 200 consistent with the disclosure. In some embodiments, as shown in FIG. 9, the acquisition circuit 110 includes a photographing circuit 112c and a processing circuit 114c. Similarly, the acquisition circuit 210 includes a photographing circuit 212c and a processing circuit 214c. The process at 512c can be implemented by the photographing circuit 112c or the photographing circuit 212c, and the process at S14c can be implemented by the processing circuit 114c and the processing circuit 214c. That is, the photographing circuit 112c or the photographing circuit 212c can be configured to obtain the hand-gesture image of the user, and the processing circuit 114c and the processing circuit 214c can be configured to obtain the hand-gesture information of the user according to the hand-gesture image.

In some embodiments, the process at S22c and the process at S24c can be implemented by the processor 120 or the processor 220. That is, the processor 120 or the processor 220 can be configured to read the hand-gesture information in the preset database and determine the user permissions according to the hand-gesture information of the user and the hand-gesture information in the preset database.

In some embodiments, the photographing circuit 112c can include a camera of the UAV 100 and the photographing circuit 212c can include a camera of the remote-control device 200, for example, a phone.

An example is described below taking the user A and the user B as an example. During the first-time operation of the UAV 100 by the user A, the camera of the corresponding device (the UAV 100 or the remote-control device 200) can be controlled to obtain a hand-gesture image of the user A or a plurality of hand-gesture images of the user A, and the hand-gesture image or the plurality of hand-gesture images can be stored. The processing circuit 114c or the processing circuit 214c can extract feature information of the hand-gesture as the hand-gesture information of the user A, according to the obtained hand-gesture image, or extract a sequence of hand-gestures in the plurality of hand-gesture images as the hand-gesture information of the user A. The user A can further set the user permissions that match the hand-gesture information. In addition, because the user A is operating the UAV 100 for the first time, the user A will be set as the owner by default or set himself as the owner, and thus the user A can have all permissions. After the match between the hand-gesture image of the user A and the user permissions is established, the preset database can be created. In some embodiments, the hand-gesture image can be an image of a certain hand-gesture of the user A, for example, an “OK” hand-gesture. In some other embodiments, the hand-gesture information can be morphological feature information of the hand-gesture extracted from the hand-gesture image. The hand-gesture information is simpler and easier to detect than the face information. Because the hand-gesture has a certain degree of privacy, the hand-gesture of the use cannot be known by other users, thereby improving the security of the UAV 100.

When the user A operates the UAV 100 again, the camera can be controlled to capture the hand-gesture image, the hand-gesture image can be processed to obtain the hand-gesture information, and the processor can compare the obtained hand-gesture information with the hand-gesture information in the preset database. If the matching between the obtained hand-gesture information and the hand-gesture information in the preset database is successful, the user A can be confirmed as an authorized user, and the permissions of the user A can be further determined. Similarly, if the user B operates the UAV 100, the obtained hand-gesture information will fail to match the hand-gesture image in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the hand-gesture information of the user B. As such, the user B can become the authorized user. In the subsequent operation, after the user B passes the match of the hand-gesture information, the user B can obtain the corresponding permissions to control the UAV 100. Users other than the user A and the user B will not have the permission to operate the UAV 100, which improves the security of the UAV 100.

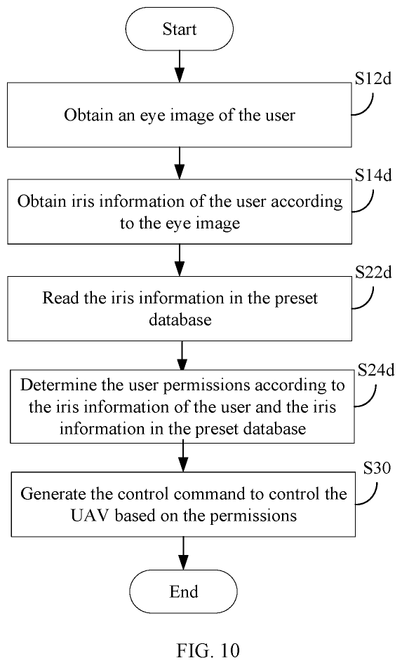

FIG. 10 is a flowchart of another example method for controlling the UAV consistent with the disclosure. In some embodiments, as shown in FIG. 10, the process at S10 can include the following processes.

At S12d, an eye image of the user is obtained.

At S14d, iris information of the user is obtained according to the eye image.

In this scenario, the process at S20 can include the following processes.

At S22d, the iris information in the preset database is read.

At S24d, the user permissions are determined according to the iris information of the user and the iris information in the preset database.

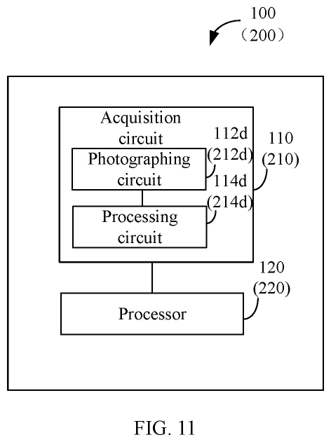

FIG. 11 is a schematic diagram of the UAV 100 or the remote-control device 200 consistent with the disclosure. In some embodiments, as shown in FIG. 11, the acquisition circuit 110 includes a photographing circuit 112d and a processing circuit 114d. Similarly, the acquisition circuit 210 includes a photographing circuit 212d and a processing circuit 214d. The process at 512d can be implemented by the photographing circuit 112d or the photographing circuit 212d, and the process at 514d can be implemented by the processing circuit 114d and the processing circuit 214d. That is, the photographing circuit 112d or the photographing circuit 212d can be configured to obtain the eye image of the user, and the processing circuit 114d and the processing circuit 214d can be configured to obtain the iris information of the user according to the eye image.

In some embodiments, the process at S22d and the process at S24d can be implemented by the processor 120 or the processor 220. That is, the processor 120 or the processor 220 can be configured to read the iris information in the preset database and determine the user permissions according to the iris information of the user and the iris information in the preset database.

In some embodiments, the photographing circuit 112d can include a camera of the UAV 100 and the photographing circuit 212d can include a camera of the remote-control device 200, for example, the camera of a phone having iris recognition function or smart glasses or smart helmet having the iris recognition function.

An example is described below taking the user A and the user B as an example. During the first-time operation of the UAV 100 by the user A, the camera of the corresponding device (the UAV 100 or the remote-control device 200) can be controlled to obtain the eye image of the user A, and the eye image can be stored. The processing circuit 114d or the processing circuit 214d can extract feature information of the eye image as the iris information of the user A, according to the obtained eye image. The user A can further set the user permissions that match the iris information. In addition, because the user A is operating the UAV 100 for the first time, the user A will be set as the owner by default or set himself as the owner, and thus the user A can have all permissions. After the match between the iris image of the user A and the user permissions is established, the preset database can be created. Compared with the face information and the gesture information, the iris information is unique and difficult to be imitated by others, thereby improving the safety of UAV. Furthermore, the operation is relatively simple, and the recognition success rate is high.

When the user A operates the UAV 100 again, the camera can be controlled to capture the eye image, the eye image can be processed to obtain the iris information, and the processor can compare the obtained iris information with the iris information in the preset database. If the matching between the obtained iris information and the iris information in the preset database is successful, the user A can be confirmed as an authorized user, and the permissions of the user A can be further determined. Similarly, if the user B operates the UAV 100, the obtained iris information will fail to match the iris image in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the iris information of the user B. As such, the user B can become the authorized user. In the subsequent operation, after the user B passes the match of the iris information, the user B can obtain the corresponding permissions to control the UAV 100. Users other than the user A and the user B will not have the permission to operate the UAV 100, which improves the security of the UAV 100.

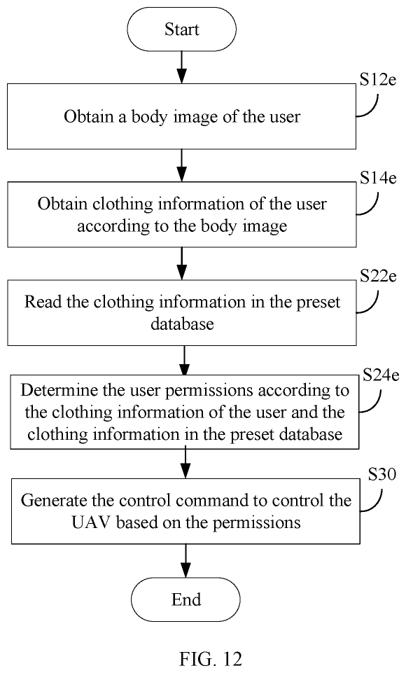

FIG. 12 is a flowchart of another example method for controlling the UAV consistent with the disclosure. In some embodiments, as shown in FIG. 12, the process at S10 can include the following processes.

At 512e, a body image of the user is obtained.

At 514e, clothing information of the user is obtained according to the body image.

In this scenario, the process at S20 can include the following processes.

At S22e, the clothing information in the preset database is read.

At S24e, the user permissions are determined, according to the clothing information of the user and the clothing information in the preset database.

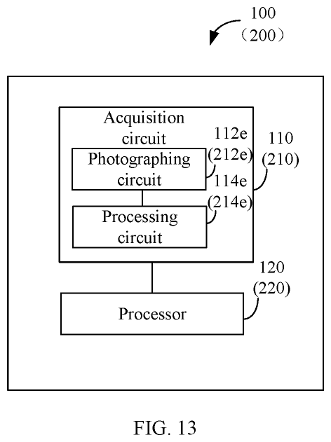

FIG. 13 is a schematic diagram of the UAV 100 or the remote-control device 200 consistent with the disclosure. In some embodiments, as shown in FIG. 13, the acquisition circuit 110 includes a photographing circuit 112e and a processing circuit 114e. Similarly, the acquisition circuit 210 includes a photographing circuit 212e and a processing circuit 214e. The process at S12e can be implemented by the photographing circuit 112e or the photographing circuit 212e, and the process at S14e can be implemented by the processing circuit 114e and the processing circuit 214e. That is, the photographing circuit 112e or the photographing circuit 212e can be configured to obtain the body image of the user, and the processing circuit 114e and the processing circuit 214e can be configured to obtain the clothing information of the user according to the body image.

In some embodiments, the process at S22e and the process at S24e can be implemented by the processor 120 or the processor 220. That is, the processor 120 or the processor 220 can be configured to read the clothing information in the preset database and determine the user permissions according to the clothing information of the user and the clothing information in the preset database.

In some embodiments, the photographing circuit 112e can include a camera of the UAV 100 and the photographing circuit 212e can include a camera of the remote-control device 200, for example, a phone.

An example is described below taking the user A and the user B as an example. During the first-time operation of the UAV 100 by the user A, the camera of the corresponding device (the UAV 100 or the remote-control device 200) can be controlled to obtain the body image of the user A, and the body image can be stored. The processing circuit 114e or the processing circuit 214e can extract feature information of the body image as the clothing information of the user A, according to the obtained body image. The user A can further set the user permissions that match the clothing information. In addition, because the user A is operating the UAV 100 for the first time, the user A will be set as the owner by default or set himself as the owner, and thus the user A can have all permissions. After the match between the clothing image of the user A and the user permissions is established, the preset database can be created. The body image may be a half-body image or a full-body image, and the clothing information may be a logo of the clothing, a color of the clothing, or the like, which is not limited herein.

When the user A operates the UAV 100 again, the camera can be controlled to capture the body image, the body image can be processed to obtain the clothing information, and the processor can compare the obtained clothing information with the clothing information in the preset database. If the matching between the obtained clothing information and the clothing information in the preset database is successful, the user A can be confirmed as an authorized user, and the permissions of the user A can be further determined. Similarly, if the user B operates the UAV 100, the obtained clothing information will fail to match the clothing image in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the clothing information of the user B. As such, the user B can become the authorized user. In the subsequent operation, after the user B passes the match of the clothing information, the user B can obtain the corresponding permissions to control the UAV 100. Users other than the user A and the user B will not have the permission to operate the UAV 100, which improves the security of the UAV 100.

In some embodiments, certain clothing information can be pre-set in the preset database, such as the clothing information of a salesperson of the UAV 100, the clothing information of a maintenance person of the UAV 100, or the like. When the UAV 100 is being sold or repaired, the relevant user can gain permission to control the UAV 100, such as a demonstration permission or a repair permission. The salesperson or maintenance person are professionals and can guarantee the safety of the UAV 100 to a certain extent. In some other embodiments, the clothing information for specific occupational groups, such as the police or management person, can be pre-set in the preset database. When an accident such as a loss of the UAV 100 occurs, the police or the management person can temporarily control the UAV 100 to ensure the safety of the UAV 100.

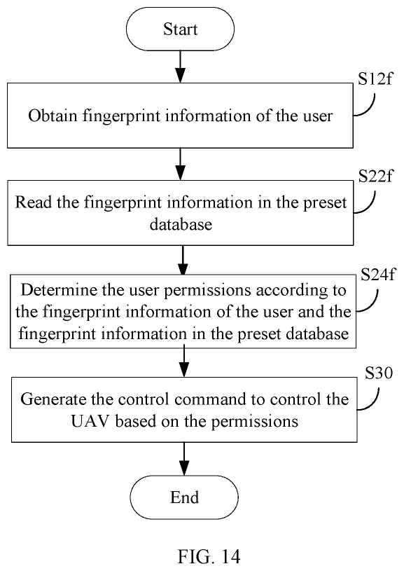

FIG. 14 is a flowchart of another example method for controlling the UAV consistent with the disclosure. In some embodiments, as shown in FIG. 14, the process at S10 can include the following process.

At S12f, fingerprint information of the user is obtained.

In this scenario, the process at S20 can include the following processes.

At S22f, the fingerprint information in the preset database is read.

At S24f, the user permissions are determined according to the fingerprint information of the user and the fingerprint information in the preset database.

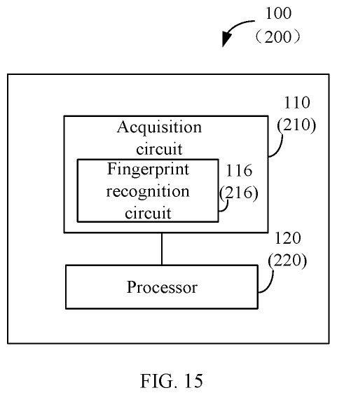

FIG. 15 is a schematic diagram of the UAV 100 or the remote-control device 200 consistent with the disclosure. In some embodiments, as shown in FIG. 15, the acquisition circuit 110 includes a fingerprint recognition circuit 116. Similarly, the acquisition circuit 210 includes a fingerprint recognition circuit 216. The process at 512f can be implemented by the fingerprint recognition circuit 116 or the fingerprint recognition circuit 216. That is, the fingerprint recognition circuit 116 or the fingerprint recognition circuit 216 can be configured to obtain the fingerprint information of the user.

In some embodiments, the process at S22f and the process at S24f can be implemented by the processor 120 or the processor 220. That is, the processor 120 or the processor 220 can be configured to read the fingerprint information in the preset database and determine the user permissions according to the fingerprint information of the user and the fingerprint information in the preset database.

In some embodiments, the fingerprint recognition circuit 116 can include a fingerprint recognition module arranged at the UAV 100, and the fingerprint recognition circuit 216 can include a fingerprint recognition module arranged at the remote-control device 200 (e.g., a phone). In some embodiments, with the development of the remote-control device 200 and the popularization of the fingerprint recognition module, obtaining the fingerprint information by the remote-control device 200 can facilitate the operation and save the cost.

An example is described below taking the user A and the user B as an example. During the first-time operation of the UAV 100 by the user A, the fingerprint information of the user A can be obtained by the corresponding fingerprint recognition circuit, and the fingerprint information can be stored. The user A can further set the user permissions that match the fingerprint information. In addition, because the user A is operating the UAV 100 for the first time, the user A will be set as the owner by default or set himself as the owner, and thus the user A can have all permissions. After the match between the fingerprint information of the user A and the user permissions is established, the preset database can be created. In some embodiments, with the development of fingerprint recognition technology, in order to prevent cheating by using a fake fingerprint or a fingerprint film, living fingerprints can be used for recognition, and thus is more secure.

When the user A operates the UAV 100 again, the fingerprint information can be obtained by the fingerprint recognition circuit, and the processor can compare the obtained fingerprint information with the fingerprint information in the preset database. If the matching between the obtained fingerprint information and the fingerprint information in the preset database is successful, the user A can be confirmed as an authorized user, and the permissions of the user A can be further determined. Similarly, if the user B operates the UAV 100, the obtained fingerprint information will fail to match the fingerprint information in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the fingerprint information of the user B. As such, the user B can become the authorized user. In the subsequent operation, after the user B passes the match of the fingerprint information, the user B can obtain the corresponding permissions to control the UAV 100. Users other than the user A and the user B will not have the permission to operate the UAV 100, which improves the security of the UAV 100.

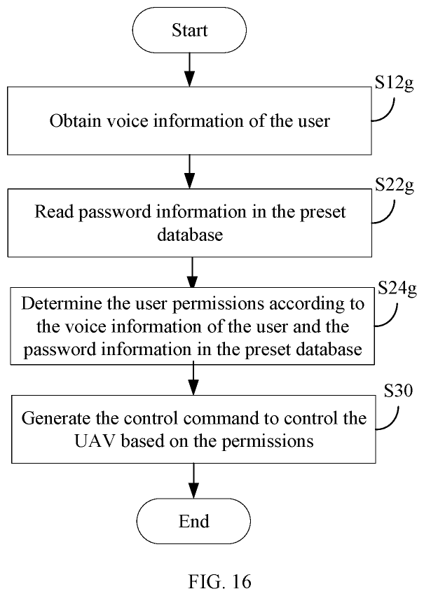

FIG. 16 is a flowchart of another example method for controlling the UAV consistent with the disclosure. In some embodiments, as shown in FIG. 16, the process at S10 can include the following process.

At 512g, voice information of the user is obtained.

In this scenario, the process at S20 can include the following processes.

At S22g, password information in the preset database is read.

At S24g, the user permissions are determined, according to the voice information of the user and the password information in the preset database.

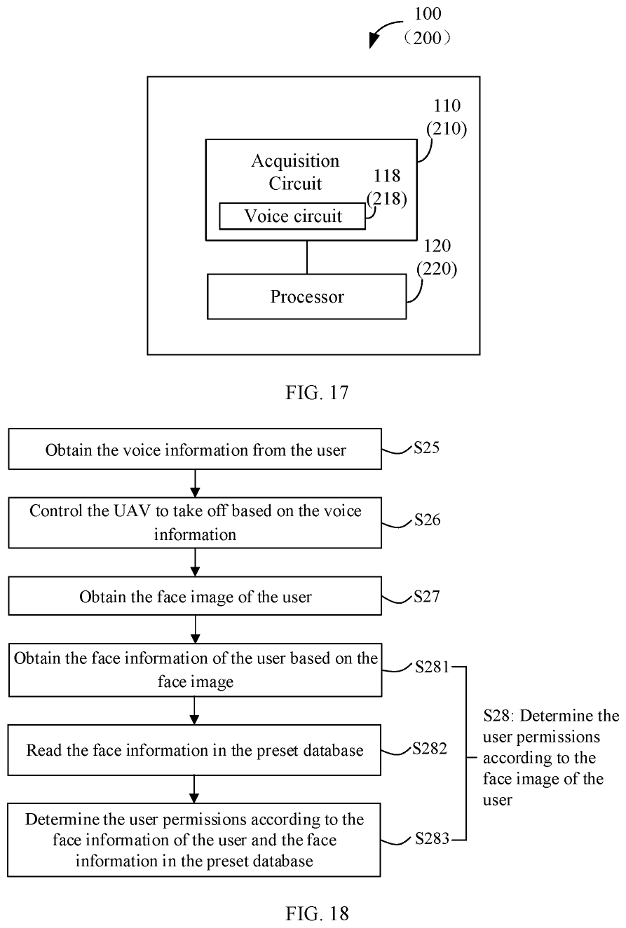

FIG. 17 is a schematic diagram of the UAV 100 or the remote-control device 200 consistent with the disclosure. In some embodiments, as shown in FIG. 17, the acquisition circuit 110 includes a voice circuit 118. Similarly, the acquisition circuit 210 includes a voice circuit 218. The process at S12g can be implemented by the voice circuit 118 or the voice circuit 218. That is, the voice circuit 118 or the voice circuit 218 can be configured to obtain the voice information of the user.

In some embodiments, the process at S22g and the process at S24g can be implemented by the processor 120 or the processor 220. That is, the processor 120 or the processor 220 can be configured to read the password information in the preset database and determine the user permissions according to the voice information of the user and the password information in the preset database.

In some embodiments, the voice circuit 118 can include a voice module arranged at the UAV 100, such as a voice recording device, and the voice circuit 218 can include a voice module arranged at the remote-control device 200, such as the voice module of the phone.

An example is described below taking the user A and the user B as an example. During the first-time operation of the UAV 100 by the user A, the voice information of the user A can be obtained by the corresponding voice circuit, and the voice information can be stored. The user A can further set the user permissions that match the voice information. In addition, because the user A is operating the UAV 100 for the first time, the user A will be set as the owner by default or set himself as the owner, and thus the user A can have all permissions. After the match between the voice information of the user A and the user permissions is established, the preset database can be created. The voice information can form the password for confirming the permissions. The password can be arbitrarily set by the user, which is not easy to leak and has high security.

When the user A operates the UAV 100 again, the voice information can be obtained by the voice circuit, and the processor can compare the voice information with the password information in the preset database using the relevant voice recognition technology. If the matching between the voice information and the password information in the preset database is successful, the user A can be confirmed as an authorized user, and the permissions of the user A can be further determined. Similarly, if the user B operates the UAV 100, the voice information will fail to match the password information in the preset database, and the user B cannot obtain the permissions to control the UAV 100. If the user B wants to be an authorized user, the user A can add the user B as a new user under the relevant permissions. Similarly, the user A can set the permissions of the user B, and associate the permissions of the user B with the voice information of the user B. As such, the user B can become the authorized user. In the subsequent operation, after the user B passes the match of the password information, the user B can obtain the corresponding permissions to control the UAV 100. Users other than the user A and the user B will not have the permission to operate the UAV 100, which improves the security of the UAV 100.

In some embodiments, the processor can perform speaker recognition. That is, in addition to recognizing the voice content by performing voice recognition technology, the speaker can also be recognized. Since different users have substantially different tones, the security of the voice recognition can be increased.

FIG. 18 is a flowchart of another example method for controlling the UAV consistent with the disclosure. In some embodiments, as shown in FIG. 18, the process at S20 can include the following processes.

At S25, the voice information is obtained from the user.

At S26, the UAV is controlled to take off based on the voice information.

At S27, the face image of the user is obtained.

At S28, the user permissions are determined according to the face image of the user.

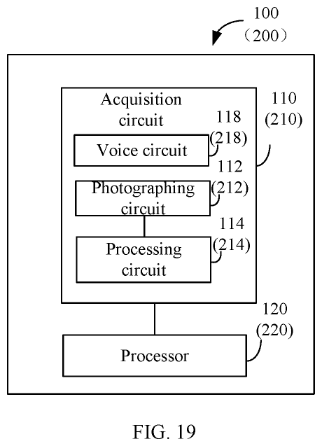

FIG. 19 is a schematic diagram of the UAV 100 or the remote-control device 200 consistent with the disclosure. In some embodiments, as shown in FIG. 19, the acquisition circuit 110 includes the voice circuit 118, the photographing circuit 112, and the processing circuit 114. Similarly, the acquisition circuit 210 includes the voice circuit 218, the photographing circuit 212, and the processing circuit 214. The process at S25 can be implemented by the voice circuit 118 or the voice circuit 218. The process at S27 can be implemented by the photographing circuit 112 or the photographing circuit 212. The processes at S26 and S28 can be implemented by the processor 120 or the processor 220. That is, the voice circuit 118 or the voice circuit 218 can be configured to obtain the voice information of the user. The photographing circuit 112 or the photographing circuit 212 can be configured to obtain the face image of the user. The processor 120 or the processor 220 can be configured to control the UAV 100 to take off based on the voice information and determine the user permissions according to the face image of the user.

In this scenario, the process at S28 can include the following processes.

At S281, the face information of the user can be obtained based on the face image.

At S282, the face information in the preset database is read.

At S283, the user permissions are determined, according to the face information of the user and the face information in the preset database.

The process at S281 can be implemented by the processing circuit 114 and the processing circuit 214. The processes at S282 and S283 can be implemented by the processor 120 or the processor 220. That is, the processing circuit 114 and the processing circuit 214 can be configured to obtain the face information of the user based on the face image. The processor 120 or the processor 220 can be configured to read the face information in the preset database and determine the user permissions according to the face information of the user and the face information in the preset database.

In some embodiments, the voice circuit 118 can include a voice module arranged at the UAV 100, such as a voice recording device, and the voice circuit 218 can include a voice module arranged at the remote-control device 200 (e.g., a phone). The photographing circuit 112 can include the camera of the UAV 100 and the photographing circuit 212 can include the camera of the remote-control device 200.

An example is described below taking the user A and the user B as an example. During the first-time operation of the UAV 100 by the user A, the voice information of the user A and the face information of the user A can be obtained by the corresponding voice circuit and the camera, and the voice information and the face information can be stored. That is, the verification information includes both password information and face information. The user A can further set the user permissions that match the voice information and the face information. In addition, because the user A is operating the UAV 100 for the first time, the user A will be set as the owner by default or set himself as the owner, and thus the user A can have all permissions. After the match between the voice information and face information of the user A and the user permissions is established, the preset database can be created. The voice message can form the password for confirming the permissions, and the face information will confirm the user permissions again after the password information, thereby further improving security.

When the user A operates the UAV 100 again, the voice information can be obtained by the voice circuit, and the processor can compare the voice information with the password information in the preset database using the relevant voice recognition technology. If the matching between the voice information and the password information in the preset database is successful, the user A can be initially confirmed as an authorized user, but the user can only control the UAV 100 to fly within a predetermined range at a predetermined height for a short time. After the UAV 100 takes off, the face information of the user A can be further compared, and if the face information also matches with the face information in the preset database, the permissions of the user A can be confirmed. Similarly, if the user B operates the UAV 100, the voice information will fail to match the password information in the preset database, and the user B cannot obtain the permissions to control the UAV 100, or even though the user B accidentally acquires the password information and can control the UAV 100 to take off, the matching cannot be completed when the face information is detected after the take-off, and the user B cannot obtain the control permission of the UAV 100. As such, the multi-validation can increase the security of the UAV 100. After the first verification fails, the subsequent verification(s) can still be used to continue the verification. When all the verifications are successful, the user can obtain the corresponding authority to control the UAV 100.

If the user B wants to be an authorized user, the user A can add the user B as a new user under the relevant permissions. Similarly, the user A can set the permissions of the user B, and associate the permissions of the user B with the voice information and the face information of the user B. As such, the user B can become the authorized user. In the subsequent operation, after the user B passes the match of the password information, the user B can control the UAV 100 to take off. After the user B further passes the match of the face information, the user B can obtain the corresponding permissions to control the UAV 100. The users other than the user A and the user B will not have the permission to operate the UAV 100, which improves the security of the UAV 100.

The combination authentication manner includes, but is not limited to, a combination of the password information and the face information, for example, a combination of any of the plurality of authentication manners as described above, for which the detailed description is omitted.

The terms “one embodiment,” “some embodiments,” “an example embodiment,” “for example,” “as a specific example,” “some examples,” or the like in the specification of the disclosure mean that the specific features, structures, materials, or characteristics described with reference to the embodiments or examples are included in at least one of the embodiments or examples of the disclosure. The use of the above terms in the specification of the disclosure may not refer to the same embodiment or example of the disclosure. In addition, the specific features, structures, materials, or characteristics described may be combined in any suitable manner in any one or more of embodiments or examples of the disclosure.

It is appreciated that any process or method described in the flowcharts or in other manners may be a module, section, or portion of program codes includes one or more of executable instructions for implementing a specific logical function or process. The disclosed methods may be implemented in other manners not described here. For example, the functions may not be performed in the order shown or discussed in the specification of the disclosure. That is, the functions may be performed basically in the same way or the reverse order according to the functions involved.

The logics and/or processes described in the flowcharts or in other manners may be, for example, an order list of the executable instructions for implementing logical functions, which may be implemented in any computer-readable storage medium and used by an instruction execution system, apparatus, or device, such as a computer-based system, a system including a processor, or another system that can fetch and execute instructions from an instruction execution system, apparatus, or device, or used in a combination of the instruction execution system, apparatus, or device. The computer-readable storage medium may be any apparatus that can contain, store, communicate, propagate, or transmit the program for using by or in a combination of the instruction execution system, apparatus, or device. The computer readable medium may include, for example, an electrical assembly having one or more wires, e.g., electronic apparatus, a portable computer disk cartridge. e.g., magnetic disk, a random access memory (RAM), a read only memory (ROM), an erasable programmable read only memory (EPROM or flash memory), an optical fiber device, or a compact disc read only memory (CDROM). In addition, the computer readable medium may be a paper or another suitable medium upon which the program can be printed. The program may be obtained electronically, for example, by optically scanning the paper or another medium, and editing, interpreting, or others processes, and then stored in a computer memory.

Those of ordinary skill in the art will appreciate that the example elements and steps described above can be implemented in electronic hardware, computer software, firmware, or a combination thereof. Multiple processes or methods may be implemented in a software or firmware stored in the memory and executed by a suitable instruction execution system. When being implemented in an electronic hardware, the example elements and processes described above may be implemented using any one or a combination of: discrete logic circuits having logic gate circuits for implementing logic functions on data signals, specific integrated circuits having suitable combinational logic gate circuits, programmable gate arrays (PGA), field programmable gate arrays (FPGAs), and the like.

Those of ordinary skill in the art will appreciate that the entire or part of a method described above may be implemented by relevant hardware instructed by a program. The program may be stored in a computer-readable storage medium. When being executed, the program includes one of the processes of the method or a combination thereof.

In addition, the functional units in the various embodiments of the present disclosure may be integrated in one processing unit, or each unit may be an individual physically unit, or two or more units may be integrated in one unit. The integrated unit described above may be implemented in electronic hardware or computer software. The integrated unit may be stored in a computer readable medium, which can be sold or used as a standalone product. The storage medium described above may be a read only memory, a magnetic disk, an optical disk, or the like.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A method for controlling an unmanned aerial vehicle (UAV) comprising:
obtaining identity information of a user;
determining a user permission according to the identity information and a preset database; and
controlling the UAV according a control command generated based on the user permission.

2. The method of claim 1, wherein obtaining the identity information of the user includes:
obtaining a face image of the user; and
processing the face image to obtain face information of the user as the identity information.

3. The method of claim 2, wherein determining the user permission includes:
reading stored face information from the preset database; and
determining the user permission according to the face information of the user and the stored face information.

4. The method of claim 1, wherein obtaining the identity information of the user includes:
obtaining a gesture image of the user; and
processing the gesture image to obtain gesture information of the user as the identity information.

5. The method of claim 4, wherein determining the user permission includes:
reading stored gesture information from the preset database; and
determining the user permission according to the gesture information of the user and the stored gesture information.

6. The method of claim 1, wherein obtaining the identity information of the user includes:
obtaining a hand-gesture image of the user; and
processing the hand-gesture image to obtain hand-gesture information as the identity information.

7. The method of claim 6, wherein determining the user permission includes:
reading stored hand-gesture information from the preset database; and
determining the user permission according to the hand-gesture information of the user and the stored hand-gesture information.

8. The method of claim 1, wherein obtaining the identity information of the user includes:
obtaining an eye image of the user; and
processing the eye image to obtain iris information of the user as the identity information.

9. The method of claim 8, wherein determining the user permission includes:
reading stored iris information from the preset database; and
determining the user permission according to the iris information of the user and the stored iris information.

10. The method of claim 1, wherein obtaining the identity information of the user includes:
obtaining a body image of the user; and
processing the body image to obtain clothing information of the user as the identity information.

11. The method of claim 10, wherein determining the user permission includes:
reading stored clothing information from the preset database; and
determining the user permission according to the clothing information of the user and the stored clothing information.

12. The method of claim 1, wherein obtaining the identity information of the user includes:
obtaining fingerprint information of the user.

13. The method of claim 12, wherein determining the user permission includes:
reading stored fingerprint information from the preset database; and
determining the user permission according to the fingerprint information of the user and the stored fingerprint information.

14. The method of claim 1, wherein obtaining the identity information of the user includes:
obtaining voice information of the user.

15. The method of claim 14, wherein determining the user permission includes:
reading stored password information from the preset database; and
determining the user permission according to the voice information of the user and the stored password information.

16. The method of claim 1, wherein:
obtaining the identity information of the user includes:
obtaining voice information from the user; and
obtaining a face image of the user; and
determining the user permission includes:
determining whether to allow the UAV to take off based on the voice information; and
determining another permission according to the face image of the user.

17. The method of claim 16, wherein determining the another permission according to the face image of the user includes:
obtaining face information of the user based on the face image;
reading stored face information from the preset database; and
determining the another permission according to the face information of the user and the stored face information.

18. The method of claim 1, wherein the user permission includes at least one of starting the UAV, prohibiting the UAV from flying, limiting a flight parameter of the UAV, limiting a flight attitude of the UAV, or limiting any one or more of shooting, tracking, and obstacle avoidance functions of the UAV.
